(19) United States
(12) Patent Application Publication
(10) Pub. No.: US 2010/0180837 A1
(43) Pub. Date: Jul. 22, 2010

(54) HYDROGEN CELL FOR MOBILE IMPLEMENTATION

(76) Inventor: Robert High, Chatfield, TX (US)

Correspondence Address: Aaron Kyle Mulvey, 518 N. Manus, Dallas, TX, 75224, US

(21) Appl. No.: 12/433,031

(22) Filed: Apr. 30, 2009

Related U.S. Application Data
(60) Provisional application No. 61/145,272, filed on Jan. 16, 2009.

(51) Int. Cl. F02B 43/08

(52) U.S. Cl. 123/3; 123/1 A

(57) ABSTRACT

An fuel cell for inducing an electrolytic effect via one or more fluids to decrease the temperature of an internal combustion engine includes, a power supply, a voltage reducer operatively connected to the power supply, and a chamber. The chamber has a cathode, an anode, and a fluid disbursement member which is operatively coupled to an intake of the internal combustion engine. The power supply transmits energy to the voltage reducer to cause the hydrogen to be produced from one or more fluids. The hydrogen is then transmitted into the intake of an internal combustion engine to cause a decrease in temperature.

### CROSS REFERENCE TO RELATED APPLICATIONS

This application claims priority to: 1.) U.S. Provisional Application No. 61/145,272, filed 16 Jan. 2009, titled “Hydrogen Cell For Mobile Implementation.”

### BACKGROUND OF THE INVENTION

1. Field of the Invention

The present invention relates to Hydrogen Cell Technology. In particular, the present invention relates to Hydrogen Cell Technology that may be implemented in Mobile Applications.

2. Description of Related Art

Over time, internal combustion engine technology has seen significant developments. Engines have evolved through the years and are able to emit considerably less pollutants into the environment. Engines presently use less toxic additives, burn cleaner fuels, and operate through emitting fewer emissions. Battery operated technologies now allow for lower emission and clean burn transportation. However, generation for higher powered machines generally requires combustion to allow for feasible transportation. Thus, efforts have shifted to gas and diesel burning technologies which focus on lowering emissions while efficient transportation.

Due to the amount of heat generated by internal combustion engines, engine blocks often require high strength materials, seals, and fluids that are able to survive in high heat environments. The use of high strength materials such as steel in engine blocks significantly increases overall weight of the car and in turn requires greater amounts of fuel to transport the entire load.

One focus of increasing efficiency involves cooling the overall temperature of engines. It is well known that circulating lower temperatures within the vicinity of an engine often leads to increased fuel efficiency. Often in wintertime, engines in operating achieve greater fuel efficiency due to lower temperatures surrounding the engine block. Operating engine components at lower temperatures allows for more efficient operation of an automobile. Other technologies have realized this effect and have attempted to mimic such effects by surrounding an engine with fluids which are more readily capable of disbursing heat. Certain technologies have included adapting water and other fluid components about exterior portions of an engine. Some technologies focus on injecting onboard fluids such as hydrogen and oxygen into various engine components.

Unfortunately, these technologies are often costly, add to the weight of the car, require maintenance, and sometimes require refueling of onboard fluids in order for the technology to work. In an effort to solve these problems other technologies have attempted to implement onboard cooling technology, but so far have been unable to sufficiently cool an internal combustion engine. Some systems employ pre-stored hydrogen containment systems, while others attempt to generate hydrogen on board. Those systems which attempt to generate hydrogen onboard do so using various components and methodologies. Certain systems which generate hydrogen onboard often requires additional power supplies, additional engines, and can become so burdensome because the components contribute significant weight to the body of the engine. Other systems have drawn current from onboard batteries, however the inability to control voltage losses, often results in failure of other onboard components.

Although these systems represent great strides in the area of hydrogen cell technology, many shortcomings remain.

Thus there exists a need for a localized cell that is capable of producing a cooling fluid energy that is lightweight and able to be powered from an onboard source.

### BRIEF DESCRIPTION OF THE DRAWINGS

The novel features believed to be characteristic of the invention are set forth in the appended claims. However, the invention itself, as well as a preferred mode of use and further objectives and advantages thereof, will best be understood by reference to the following detailed description when read in conjunction with the accompanying drawings, wherein:

FIG. 1 illustrates a perspective view of a fuel cell.

FIG. 2 illustrates a side view of a chamber which is included in the fuel cell as illustrated in FIG. 1.

FIG. 3 illustrates an exploded perspective view of a series of conductive members separated from the chamber illustrated in FIG. 2.

FIG. 4 illustrates a partial close up side view of the series of conductive members shown in FIG. 3.

FIG. 5 illustrates an alternate side view of the series of conductive members shown in FIG. 3 and FIG. 4.

FIG. 6 illustrates a schematic view of an embodiment of a fuel cell operably coupled to a power source.

### DETAILED DESCRIPTION OF THE PREFERRED EMBODIMENT

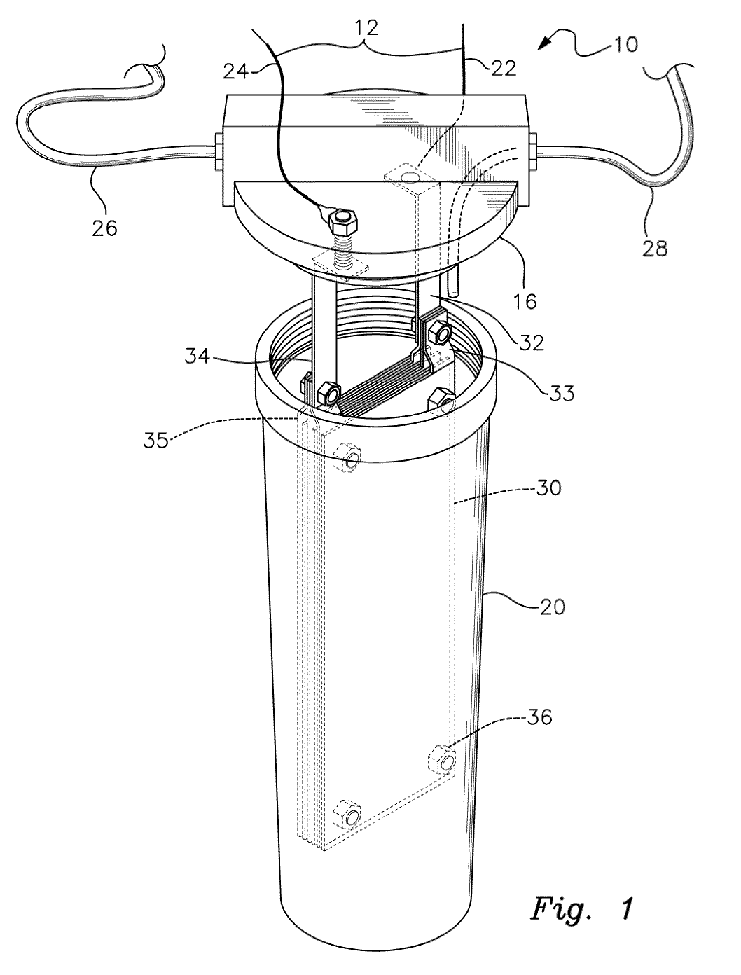

Referring now to the figures, FIG. 1 illustrates a perspective view of fuel cell 10. Fuel cell 10 induces an electrolytic effect via one or more fluids to decrease the temperature of an internal combustion engine. Fuel cell 10 includes power supply 12, at least one voltage reducer (not shown) operatively connected to power supply 12, chamber 20 connected to a cathode 22, an anode 24, and a fluid disbursement member 26 operatively coupled to an internal combustion engine. Power supply 12 transmits energy to at least one voltage reducer (not shown) for causing hydrogen to be produced from one or more fluids. As hydrogen is produced, it is then transmitted towards internal combustion engine which subsequently causes the internal combustion engine to decrease in temperature.

Fuel cell 10 is preferably constructed out of chamber 20 which includes lid member 16 being configured to adapt cathode 22, anode 24, fluid disbursement member 26, and fluid input member 28. In a preferred embodiment fluid input member 28 extends through lid member 16 for distributing one or more fluids into chamber 20. Similarly, fluid disbursement member 26 extends about lid member 16 for distributing one or more fluids from chamber 20. Chamber 20 and lid member 16 are formed to temporarily couple about one another to seal and prevent the escape of air and other fluids. Lid member 16 of fuel cell 10 is preferably of a screw type which is grooved to conform to corresponding grooves preferably extending from a edge of chamber 20. In alternative embodiments lid member 16 and chamber 20 may mate with one another in any variety of manners including snapping, button attachment means, snapping means, hook and loop adapters. In still other embodiments, lid member 16 and chamber 20 may permanently couple about one another. In yet other embodiments, lid member 16 and chamber 20 may be made of other materials and combinations of materials including plastics, metals, composites, wood, rigid fibers, along with epoxies and various other resins.

In a preferred embodiment, lid member 16 receives cathode 22 and anode 24 along with fluid disbursement member 26. Cathode 22, anode 24 and fluid disbursement member 26 extend through lid member 16 and into chamber 20. A seal exists between cathode 22 and lid member 16 to prevent escape of fluid from chamber 20. A seal exists between anode 24 and lid member 16 to prevent escape of fluid from chamber 20. In certain embodiments, when one or more fluids are disposed within chamber 20, an air layer exists between an uppermost portion of one or more fluids and lid member 16, cathode 22, anode 24, and fluid disbursement member 26. Fluid disbursement member 26 operably extends through lid member 16.

In alternative embodiments, fluid input member 28, cathode 22, anode 24, and fluid disbursement member 26 all extend about various portions of chamber 20 and lid member 16. For example, in certain embodiments, fluid input member 28 and anode 24 may extend about a wall of chamber 20, while cathode 22 and fluid disbursement member 26 extend from lid member 16 and anode 24. Similarly, in other embodiments, anode 24 and cathode 22 may extend about a bottom of chamber 20 while fluid disbursement member 26 extends from lid member 16. In yet other embodiments cathode 22, anode 24, fluid input member 28, may extend through a bottom of chamber 20, while fluid disbursement member 26 extends through lid member 16 or through chamber 20. In other embodiments, multiple cathodes, anodes, fluid disbursement members, and fluid input members may extend throughout lid member 16 or chamber 20. In an alternative embodiment chamber 20 and lid member 16 may take alternative shapes and forms so long as a seal is created. In yet other alternative embodiments a self contained chamber may exist so long as it allows for transmission of current and energy. For example in certain embodiments a single tubing component may be employed to transmit fluid into chamber 20 and allow fluid to be disbursed from chamber 20. In one instance, a singular tubing component may be separated into one or more channels to allow for simultaneous relay of fluid into and out of chamber 20. In another instance, a singular tubing component may intermittently transmit fluid into chamber 20 and subsequently allow for fluid to escape from chamber 20 or visa versa.

Conductive extension 32 and conductive extension 34 extends from cathode 22 and anode 24. Conductive extension 32 and conductive extension 34 are preferably immersed in one or more fluids to allow for current transmission into flange members. Conductive flange member 33 couples to extension 32. Conductive flange member 35 couples to extension 34. A series of conductive members are operatively coupled to flange member 33 and flange member 35. Series of conductive members 30 are arranged in alternating fashion to transmit positive and negative current through one or more fluids disposed in chamber 20 in alternating order. Series of conductive members 30 are separated from one another anywhere from 1/16 of 1 inch to 2 inches. Series of conductive members 30 remain stabilized from one another via nonconductive coupling members 36. Nonconductive coupling members 36 include a nonconductive bolt and screw combination along with one or more non-conductive spacing mechanisms. Each spacing mechanism separates each of conductive members 30. Each of one or more spacing mechanisms span a width that may range between 1/16 of 1 inch to 2 inches. In a preferred embodiment each of series of conducive members 30 span a width ranging between 1/16 of 1 inch to 2 inches. It is preferred that in certain embodiments, series of conductive members 30 and non-conductive spacing mechanisms are of the same width. In a preferred embodiment, non-conductive spacing mechanisms and series of conductive members 30 are approximately 1/16 of one inch.

In the present illustration, series of conductive members 30 are separated and stabilized relative to one another via nonconductive coupling member combinations 36 and nonconductive spacing combinations. A set of two nonconductive coupling member combinations 36 couple conductive extension 32 to conductive flanges 33 and conductive extension 34 to conductive flanges 35. Each of conductive flanges 33 and conductive flanges 35 abut one another to allow for constant current transmission.

In a preferred embodiment of the present application series of conductive members 30 include approximately 3 plates which extend about a substantial length of chamber 20. Series of conductive members 30 are preferably made from stainless steel. Non conductive members 36 and nonconductive spacing member 38 are preferably made out of Teflon. Series of conductive members 30 include a rectangular body and width which extends to approximately the same amount as the width of series of nonconductive spacing members 38. Series of conductive members 30 are separated from an inner wall of chamber 20 by a range of 1/10 of 1 inch to ½ of 1 inch. Faces of series of conductive members 30 are separated from an inner wall of chamber 20 by approximately ½ of 1 inch. Conductive extension 34 extends to approximately 1 inch from lid member 16 to flange member 35. Conductive extension 32 extends approximately 1 inch from lid member 16 to flange member 33. Screw-bolt combinations couple conductive extensions 34 and 32 to lid member 16.

Fluid disbursement member 26 extends from a supply not pictured through lid member 16 and into chamber 20. In a preferred embodiment of the present application, a majority of fluid disbursement member 26 remains immersed in one or more fluids. Fluid disbursement member 26 is substantially flexible to allow for the transmission of one more fluids in a noncorrosive environment. Fluid disbursement member 26 is preferably made from of a semi-rigid polymeric material.

In an alternative embodiment of the present application, series of conductive members 30 may take alternate shapes. For example series of conductive members 30 may be substantially ovular, substantially triangular, and may adapt to any other shape so long as they conform to the confines of chamber 20. Fluid disbursement member 26 should remain operatively disposed about one or more fluids for releasing hydrogen from fuel cell 10.

Cathode 22 couples to at least one first extending member 32 that is operatively disposed about one or more fluids. Anode 24 couples to at least one second extending member 34 that is operatively disposed about one or more fluids. In a preferred embodiment, at least one first extending member 32 and at least one second extending 34 member are operatively disposed parallel to one another and are separated from one another by at least one-eighth of an inch. In another embodiment, cathode 22 includes two or more extending members and anode 24 includes two or more extending members which are operatively disposed parallel to one another and are separated from one another such that each first extending member and each second extending member aligns next to one another in an alternating fashion so that each first extending member is separated from another first extending member by a second extending member. In a preferred embodiment, at least one first extending member 32 and at least one second extending member 34 are separated from one another by a non-conductive spacing member such as a washer. In another embodiment, first extending member 32 and second extending member 34 are substantially rectangular conductive members. In other embodiments, first extending members and second extending members are separated from one another by less than one-eighth of an inch. In certain embodiments first extending members and second extending members are made of stainless steel.

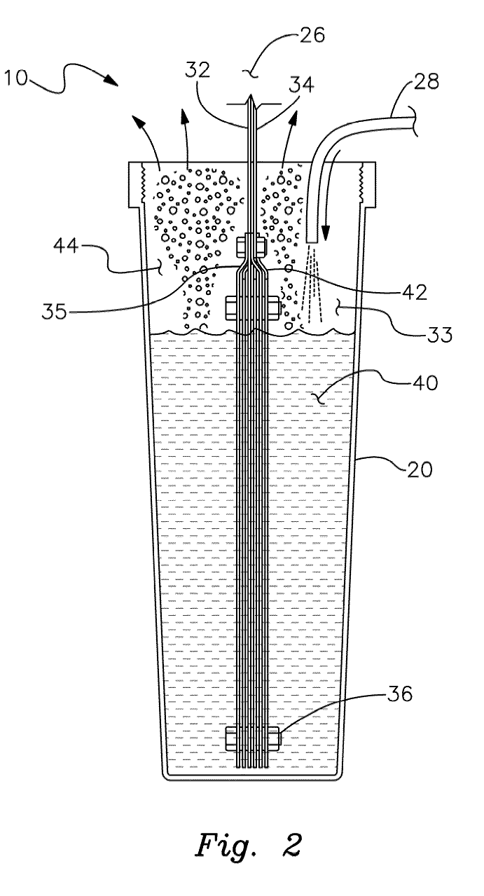

Referring now to FIG. 2, a side view of chamber 20 which is a component part of fuel cell 10 is illustrated according to a preferred embodiment of the present application. One or more fluids 40 are disposed within chamber 20 and substantially fill chamber 20. Second fluid 42 is disposed above fluid 40. Fluid input member 28 is situated to deposit one or more fluids 40 into chamber 20. At end of fluid input member 28 is disposed within fluid 42 to allow for freefall of fluid 40 into chamber 20. In certain embodiments of fluid input member 28 may be disposed within fluid 40.

In operation, as fluid input member 28 allows for deposit of one more fluids 40 into chamber 20 and chamber 20 begins to accumulate fluid, fuel cell 10 begins to operate allowing for transmission of current through conductive extension 32 and conductive extension 34. Conductive extension 32 and conductive extension 34 transmit power through conductive flanges 33 and 35 and series of conductive members 30 through one or more fluids 40 to create an electrolytic effect. An electrolytic effect allows for separation of one or more fluids 40 into component molecules 44. In a preferred embodiment, one or more fluids 40 substantially consist of water, allowing component molecules 44 become water and air. Employment of an electrolytic effect allows for separation of oxygen and hydrogen molecules from water. Hydrogen molecules are released from one more fluids 40 into fluid 42 and travel into fluid disbursement member 26. Oxygen molecules cause pitting of conductive members 30. As an electrolytic effect causes one more fluids 40 to separate into a gaseous state, additional fluid is applied via fluid input member 28.

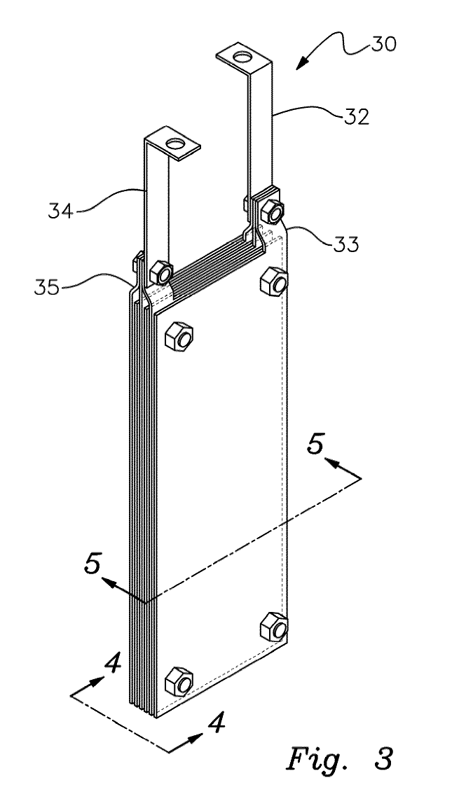

Referring now to FIG. 3 an exploded view of a series of conductive members 30, conductive flanges 33 and 35, and conductive extensions 32 and 34, coupled via non-conductive coupling members 36 and non conductive spacing members 38 as shown in FIGS. 1 and 2 is illustrated according to a preferred embodiment of the present application.

As shown, conductive members 32, are oriented to carry a positive charge while conductive members 34 are oriented to carry a negative charge. As current travels through conductive member 32, it is transmitted through conductive flange 33. As current travels through conductive extension 34 it is transmitted through conductive flange 35. In an alternative embodiment, conductive members 32 and conductive members 34 may extend to variable lengths. For example conductive members 32 may each extend to different lengths or conductive members 32 in combination may extend to a same length, but different from the length of conductive members 34. Similarly, conductive members 34 may each extend to different lengths or conductive members 34 in combination may extend to a same length, but different from a length of conductive members 32.

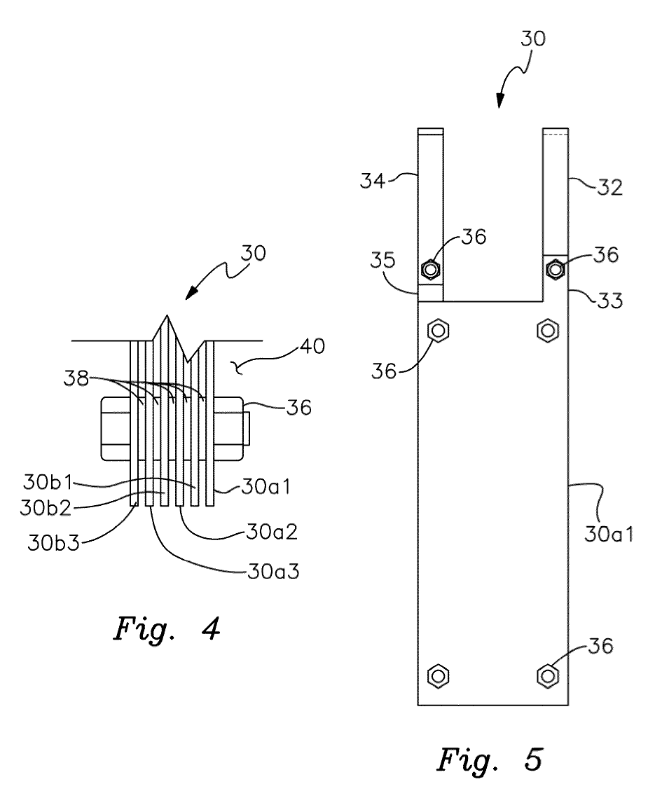

Referring now to FIG. 4, a close-up cutout view of conductive members 30 as shown in FIG. 1, FIG. 2, and FIG. 3, separated by nonconductive spacing member 38 and conductive coupling members 36 is illustrated according to a preferred embodiment of the present application. As is shown nonconductive spacing members 38 separate conductive members 30a1 from 30b1, 30b1 from 30a2, 30a2 from 30b2, 30b2 from 30a3, and 30a3 from 30b3 at equidistant intervals. By keeping series of conductive members 30 separate in these intervals for transmission of current allows for approximately a same amount of release of hydrogen from water more fluids 40 stabilization of nonconductive coupling member 36 insurers a stabilization of nonconductive spacing members 38.

Referring now to FIG. 5 a side view of a series of conductive members 30 is illustrated according to a preferred embodiment of the present application. Conductive extension 32 extends to meet conductive flange 33 which is coupled to conductive member 30a1. Conductive extension 34 extends to meet conductive flange 35 which is coupled to conductive member 30 stabilizing series of conductive members 30 are nonconductive coupling members 36. Additional nonconductive members 36 stabilize flange members 33 and 35.

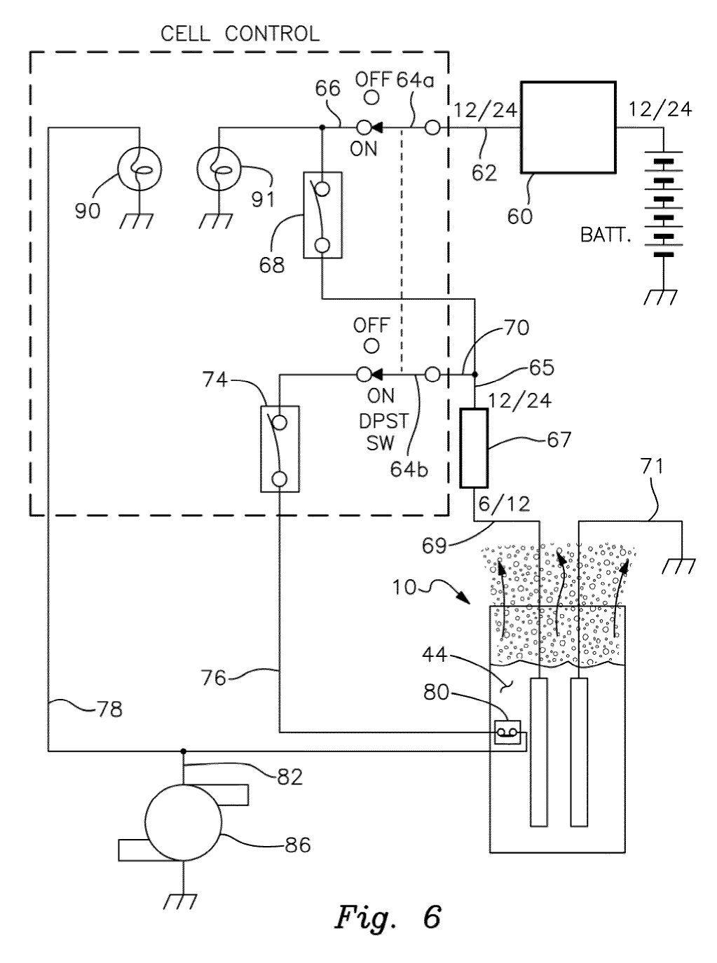

Referring now to FIG. 6, a schematic of an embodiment of fuel cell 10 operably coupled to a power source is illustrated. First line 62 extends from fuse box 60 to a first switch 64. First switch 64a allows for the transmission of power to first circuit breaker 68 and indicator light 91 via second line 66. Second line 66 extends from first switch 64a to first circuit breaker 68. Third line 70 extends from second switch 64b to second circuit breaker 74. Fourth line 76 extends from second circuit breaker 74 to floating apparatus 80 which is operably disposed about fluid medium 44 and preferably confined within chamber 20. Fifth line 82 extends to allow operable communication between floating apparatus 80 and reserve chamber 86. Sixth line 78 extends from floating apparatus 80 to indicator light 90. Seventh line 65 extends from first circuit breaker 68 to voltage reducer 67. Eighth line 69 extends from voltage reducer 67 to anode 24.

In operation, first switch 64 is toggled to supply power to floating apparatus 80 and anode 24 via voltage reducer 67. Floating apparatus 80 measures fluid level disposed in chamber 20 to determine whether fluid needs to be conveyed from said water reserve chamber. In the event a fluid level is too low, fluid is conveyed through fluid disbursement member 26 (shown in FIG. 1) into chamber 20. When floating apparatus 80 reaches an adequate level indicating that sufficient fluid is disposed within chamber 20, a signal is communicated via fourth line 76 through second circuit breaker 74, second switch 72, and first switch 64 to allow for transmission of current. Simultaneously, current is transmitted from a power source through fuse box 60 through first switch 64 and first circuit breaker 68 into a voltage reducer and through fuel cell 10. As fuel cell 10 transmits current 10 to in turn generate hydrogen, additional voltage requested from a power source via fuse box 60 from power generating cell 10 and through voltage reducer 67. Accordingly, voltage reducer 67 allows for a maximum amount of voltage to be transmitted to power generating cell 10. In a preferred embodiment, voltage transmitted through fuse box 60 at 12 volts is reduced to 6 volts. In yet an alternative embodiment, voltage transmitted through fuse box 60 at 24 volts is reduced to 12 volts. In the event that fluid level 44 becomes too low, a first circuit breaker is tripped, preventing pull of additional current from power supply 60. In the event that reserve chamber 86 is in capable of transmitting fluid into fuel cell 10, sixth line transmits current to indicator light 90 which is disposed within an operator's visibility. Voltage reducer 67 reduces the amount of voltage supplied from the power source to a desired voltage while preventing fuel cell 10 from pulling an overabundance of voltage. In any event, voltage reducer 67 prevents excess voltage from being transmitted from the power source, while maintaining a constant transmission of voltage to fuel cell 10.

In an alternative embodiment of the present application, an additional tube may be operatively coupled to fuel cell 10. A check valve extends from one end of the additional tube, while another end of the tube extends into a portion of a reserve chamber 86. As current is transmitted through series of conductive members 30, and additional fluid is required, head pressure is created as water is drawn from the reserve chamber 86 into chamber 20 via fluid input member 28. The check valve allows for a one way transmission of another fluid such as air into the reserve chamber 86 to displace the fluid caused by the transmission of additional fluid into chamber 20. In an alternative embodiment additional tubes may be operatively associated with chamber 20 and a reserve chamber 86 for head pressure in numerous ways. For example, in an alternative embodiment, an additional tube may include a check valve and operatively couple to a portion of chamber 20 while another tube not having a check valve may couple to a reserve chamber 86 which allows for transmission of fluid into chamber 20 via fluid input member 28.

Various components of fuel cell 10 may be made from a wide variety of materials. These materials may include metallic or non-metallic, magnetic or non-magnetic, elastomeric or non-elastomeric, malleable or non-malleable materials. Non-limiting examples of suitable materials include metals, plastics, polymers, wood, alloys, composites and the like. The metals may be selected from one or more metals, such as steel, stainless steel, aluminum, titanium, nickel, magnesium, or any other structural metal. Examples of plastics or polymers may include, but are not limited to, nylon, polyethylene (PE), polypropylene (PP), polyester (PE), polytetraflouroethylene (PTFE), acrylonitrile butadiene styrene (ABS), polyvinylchloride (PVC), or polycarbonate and combinations thereof, among other plastics. Fuel cell 10 and its various components may be molded, sintered, machined and/or combinations thereof to form the required pieces for assembly. Furthermore each fuel cell and its various components may be manufactured using injection molding, sintering, die casting, or machining.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All of the compositions and/or methods disclosed and claimed herein can be made and executed without undue experimentation in light of the present disclosure. While the compositions and methods of this invention have been described in terms of various embodiments, it will be apparent to those of skill in the art that other variations can be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A fuel cell for inducing an electrolytic effect via one or more fluids to decrease the temperature of an internal combustion engine comprising:
A power supply;
A voltage reducer operatively connected to the power supply; and
A chamber having a cathode, an anode, and a fluid disbursement member operatively coupled to an intake of the internal combustion engine;
Wherein the power supply transmits energy to the voltage reducer for causing hydrogen to be produced from the one or more fluids; and
Wherein said hydrogen is transmitted into said intake for causing said internal combustion engine to decrease in temperature.

2. The fuel cell of claim 1 further comprising at least one more fluid is disposed within the chamber wherein at least a portion of the cathode and the anode are submersed in the one or more fluids.

3. The fuel cell of claim 2, wherein at least one of the one or more fluids is water.

4. The fuel cell of claim 1, wherein the voltage reducer maintains a constant voltage.

5. The fuel cell of claim 1, wherein the voltage reducer maintains a variable tolerance that fluctuates between 0.1 and 1.6 volts from a desired voltage.

6. The fuel cell of claim 1, wherein the voltage reducer maintains a variable tolerance that fluctuates between 0.1 and 4 volts of a desired voltage.

7. The fuel cell of claim 1, further comprising a reserve chamber; and
wherein the chamber is operatively coupled to the reserve chamber to communicates one or more additional fluids to the chamber.

8. The fuel cell of claim 1, wherein the voltage reducer is a electronic voltage reducer.

9. The fuel cell of claim 1, wherein the voltage reducer reduces voltage from 24 volts to a range between 13 volts and 8 volts.

10. The fuel cell of claim 1, wherein the voltage reducer reduces voltage from 12 volts to a range between 6 volts and 4.4 volts.

11. The fuel cell of claim 1, further comprising at least one circuit breaker operatively coupled between the voltage reducer and the electrical power supply for allowing the fuel cell to be turned on and off.

12. The fuel cell of claim 1, further comprising at least one triggering mechanism for automatically refilling the chamber with one or more fluids.

13. The fuel cell of claim 1, wherein the hydrogen is generated within two inches of the cathode.

14. The fuel cell of claim 1, further comprising at least one interrupt operatively coupled between the power supply and the voltage reducer for intermittently transmitting gasses into the intake manifold.

15. The fuel cell of claim 1, wherein at least 1 half-inch gap or air separates the at least one fluid in which the cathode and the anode are submersed.

16. The fuel cell of claim 1, wherein a flash suppressor operatively disposed between the disbursement member and the intake manifold.

17. The fuel cell of claim 1, further comprising:
a first circuit breaker;
a second circuit breaker; and

18. A fuel cell for inducing an electrolytic effect via one or more gasses to decrease the temperature of an internal combustion engine comprising:
An electrical power supply;
A voltage reducer operatively connected to the electrical power supply;
A chamber having a cathode, an anode, and a disbursement member operatively connected an intake manifold of the internal combustion engine;
An exit operatively connected to the intake manifold of the internal combustion engine;
A reserve chamber operatively coupled to the chamber for conveying fluid to the chamber;
Wherein the electrical power supply supplies current the voltage reducer to cause hydrogen to be produced proximal to the cathode; and
Wherein one or more gasses are transmitted into the intake manifold to produce a change in temperature.

19. The fuel cell of claim 15, further comprising one or more circuit breakers operatively connected between the power supply and the voltage reducer for selectively operating the fuel cell.

20. The fuel cell of claim 15, the chamber further comprising a filtration member extending from the disbursement member for preventing backflow from the intake manifold.
